(19) United States
(12) Patent Application Publication
(10) Pub. No.: US 2026/0084219 A1
(43) Pub. Date: Mar. 26, 2026

(54) CUTTING INSERT, CUTTING TOOL, AND METHOD FOR MANUFACTURING MACHINED PRODUCT

(71) Applicant: KYOCERA CORPORATION, Kyoto-shi, Kyoto (JP)

(72) Inventor: Yoshihito IKEDA, Ritto-shi, Shiga (JP)

(21) Appl. No.: 19/112,594

(22) PCT Filed: Sep. 13, 2023
(86) PCT No.: PCT/JP2023/033346

§ 371 Date: Mar. 18, 2025

(30) Foreign Application Priority Data
Sep. 22, 2022 (JP) 2022-151559

(51) Int. Cl. B23B 27/10; B23B 27/14

(52) U.S. Cl. CPC B23B 27/10; B23B 27/14; B23B 2226/125; B23B 2226/315; B23B 2250/121

(57) ABSTRACT

A cutting insert in an aspect of the present disclosure has a cutting part. The cutting part has a first surface, a second surface, a third surface located between the first surface and the second surface, and a flow path extending from the first surface toward the second surface. The flow path has an outflow port opening into the first surface, and a first flow path extending from the outflow port toward the second surface. In a first cross section that passes through a central axis of the first flow path and is orthogonal to the first surface, a width of the first flow path in a direction parallel to the first surface increases as going away from the first surface.

### CROSS-REFERENCE TO RELATED APPLICATION

The present application claims priority to Japanese Patent Application No. 2022-151559, filed Sep. 22, 2022. The contents of this application are incorporated herein by reference in their entirety.

### TECHNICAL FIELD

The present aspect relates to a cutting insert, a cutting tool, and a method for manufacturing a machined product.

### BACKGROUND

As a cutting insert of a cutting tool used for machining a workpiece, cutting inserts have been known which are discussed in, for example, Japanese Unexamined Patent Publication No. 5-116008 (Patent Document 1) and WO 2021/074979 (Patent Document 2). The cutting inserts discussed in Patent Document 1 and Patent Document 2 have therein a flow path that permits flow of a coolant for cooling the cutting insert.

Because these cutting inserts have the flow path disposed therein, it is possible to efficiently supply the coolant to a cutting edge during machining, thereby enhancing durability of the cutting insert.

If the cutting insert has the flow path disposed therein, there is a desire for more efficient supply of the coolant to the cutting edge during machining.

### SUMMARY

A cutting insert in an aspect of the present disclosure has a cutting part. The cutting part has a first surface having a rake surface region, a second surface located on a side opposite to the first surface, a third surface that is located between the first surface and the second surface and has a flank surface region, and a flow path extending from the first surface toward the second surface. The flow path has an outflow port opening into the first surface, and a first flow path extending from the outflow port toward the second surface. In a first cross section that passes through a central axis of the first flow path and is orthogonal to the first surface, a width of the first flow path in a direction parallel to the first surface increases as going away from the first surface.

### BRIEF DESCRIPTION OF THE DRAWINGS

FIG. 1 is a perspective view illustrating a cutting insert of a first embodiment;

FIG. 2 is a plan view of the cutting insert illustrated in FIG. 1 as viewed from A1 direction;

FIG. 3 is an enlarged view of a region B1 illustrated in FIG. 1;

FIG. 4 is an enlarged view of a region B2 illustrated in FIG. 2;

FIG. 5 is an enlarged view of a cross section taken along line V-V illustrated in FIG. 4;

FIG. 6 illustrates a modification of a first flow path of the cutting insert in the first embodiment, and corresponds to FIG. 5;

FIG. 7 is an enlarged view of a region B3 illustrated in FIG. 5;

FIG. 8 is an enlarged view of a cross section taken along line VII-VII illustrated in FIGS. 4 and 5;

FIG. 9 is an enlarged view of a cross section taken along line VIII-VIII illustrated in FIGS. 4 and 5;

FIG. 10 is an enlarged view illustrating a cutting insert of a second embodiment, and corresponds to FIG. 3;

FIG. 11 is an enlarged view illustrating the cutting insert of the second embodiment, and corresponds to FIG. 4;

FIG. 12 is an enlarged view of a cross section taken along line XI-XI illustrated in FIG. 11, and corresponds to FIG. 5;

FIG. 13 is an enlarged view of a cross section taken along line XII-XII illustrated in FIGS. 11 and 12, and corresponds to FIG. 8;

FIG. 14 is an enlarged view of a cross section taken along line XIII-XIII illustrated in FIGS. 11 and 12, and corresponds to FIG. 9;

FIG. 15 is a side view illustrating a cutting tool in an embodiment of the present disclosure;

FIG. 16 is a diagram illustrating one of steps in a method for manufacturing a machined product in an embodiment of the present disclosure;

FIG. 17 is a diagram illustrating one of the steps in the method for manufacturing a machined product in the embodiment of the present disclosure; and

FIG. 18 is a diagram illustrating one of the steps in the method for manufacturing a machined product in the embodiment of the present disclosure.

### EMBODIMENTS

### Cutting Inserts

A cutting insert (hereinafter referred to as an insert in some cases) in a non-limiting embodiment of the present disclosure is described in detail below with reference to the drawings. Specifically, cutting inserts of first and second embodiments are individually described in detail with reference to the drawings. For the convenience of description, the drawings referred to in the following illustrate, in simplified form, only main members necessary for describing the inserts of these embodiments. The inserts of the present disclosure may therefore have any arbitrary structural member not illustrated in the drawings referred to. Dimensions of the members in each of the drawings faithfully represent neither dimensions of actual structural members nor dimensional ratios of these members.

The insert of the first embodiment and the insert of the second embodiment are respectively called and described as the insert 1A and the inset 1B. However, in the case of describing configurations, etc. common to both, the insert 1A and the insert 1B are called the insert 1 for the convenience of description.

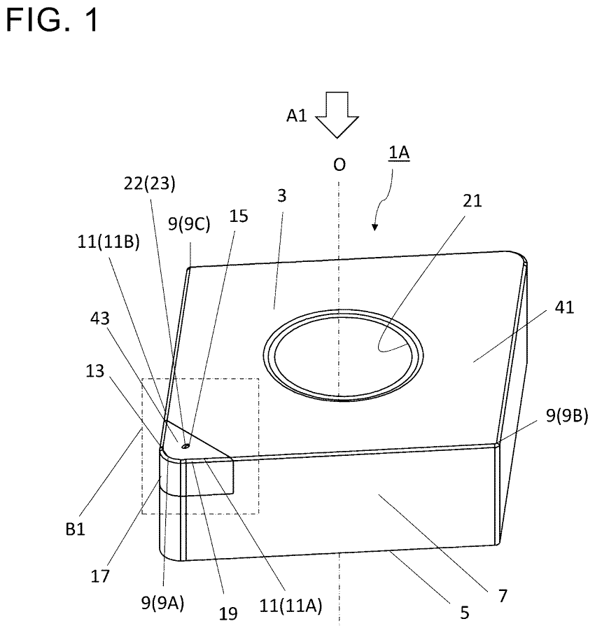

As in the non-limiting embodiment illustrated in FIG. 1, the insert 1A of the first embodiment has a first surface 3 (upper surface), a second surface 5 (lower surface) located on a side opposite to the first surface 3, and a third surface 7 (lateral surface) located between the first surface 3 and the second surface 5.

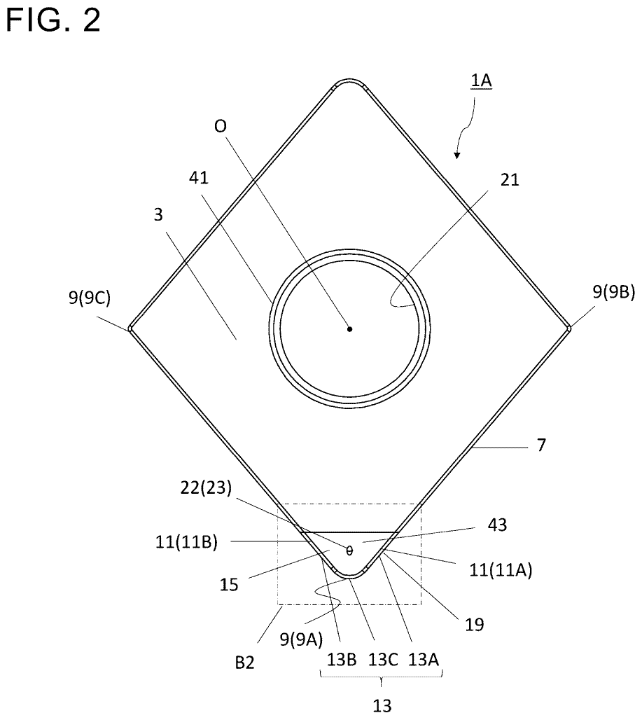

The first surface 3 and the second surface 5 have a polygonal shape, which is a rhombus shape in a non-limiting embodiment illustrated in FIG. 2. Therefore, the first surface 3 in the non-limiting embodiment illustrated in FIG. 2 has four corners 9 and four sides 11. In the insert 1A illustrated in the non-limiting embodiment illustrated in FIG. 2, the third surface 7 has four surfaces, each of which has an approximately rectangular shape.

In the non-limiting embodiment illustrated in FIG. 2, the first surface 3 has a plurality of corners 9 and a plurality of sides 11. Specifically, the first surface 3 has a first corner 9A, a second corner 9B, and a third corner 9C. The first corner 9A is one of the plurality of corners 9. The second corner 9B and the third corner 9C are located adjacent to the first corner 9A among the plurality of corners 9. The first surface 3 also has a first side 11A extending from the first corner 9A to the second corner 9B, and a second side 11B extending from the first corner 9A to the third corner 9C.

FIG. 2 is a plan view of the cutting insert 1A illustrated in FIG. 1 as viewed from Al direction, specifically a diagram of the first surface 3 as viewed from the front. Hereinafter, a front view of the first surface 3 may be rephrased as a top view thereof. The second corner 9B is located on a right side of the insert 1, and the third corner 3C is located on a left side of the insert 1 in FIG. 2, and vice versa.

If the insert 1 is viewed from above as in the non-limiting embodiment illustrated in FIG. 2, each of the corners 9 has a curvilinear shape, and a radius of curvature of the corners 9 may be, for example, constant. If the insert 1 is viewed from above in the non-limiting embodiment illustrated in FIG. 2, each of the sides has a straight line shape.

The insert 1 also has a cutting edge 13. In the non-limiting embodiment illustrated in FIG. 2, the cutting edge 13 has a first cutting edge 13A located along a part of the first side 11A, a second cutting edge 13B located along a part of the second side 11B, and a first corner cutting edge 13C located along the whole of the first corner 9A.

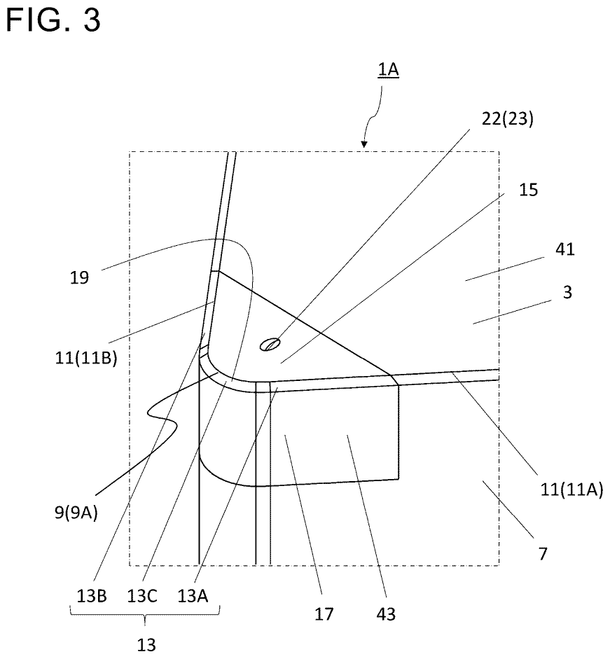

In a non-limiting embodiment illustrated in FIG. 3, the first cutting edge 13A and the second cutting edge 13B are respectively located along the first side 11A and the second side 11B, and therefore have a straight line shape. The first corner cutting edge 13C is located along the first corner 9A, and therefore has a curvilinear shape. Here, a radius of curvature of the first corner cutting edge 13C may be constant. Additionally, because the insert 1 has the cutting edge 13 between the first surface 3 and the third surface 7 in the non-limiting embodiment illustrated in FIG. 3, the first surface 3 has a rake surface region 15, and the third surface 7 has a flank surface region 17.

In the non-limiting embodiment illustrated in FIG. 3, the insert 1 has a land surface 19 located between the first surface 3 and the third surface 7. Here, the land surface 19 is a belt-shaped surface region disposed along the cutting edge 13 in order to avoid chipping of the cutting edge 13. For the convenience of manufacturing, the insert 1 also has a surface having the same shape as the land surface 19 in a part where the cutting edge 13 is not located in the non-limiting embodiment illustrated in FIG. 2.

The cutting edge 13 may be located on an intersection of the first surface 3 and the third surface 7, but not limited to this. For example, if the insert 1 has the land surface 19 or the surface having the same shape as the land surface 19 as described above, the cutting edge 13 may be located on an intersection of the land surface 19 and the third surface 7.

Although dimensions of the insert 1 are not particularly limited, for example, a length of the first side 11A is set to 3-20 mm in the insert 1A of the first embodiment. A height from the first surface 3 to the second surface 5 is set to 2-20 mm.

The insert 1 also has a through hole 21 that opens into the first surface 3 and the second surface 5 in the non-limiting embodiment illustrated in FIG. 1. The through hole 21 is used as a hole that permits insertion of a fixture when attaching the insert 11 to a holder. Examples of the fixture may have a screw, a clamping member, and a wedge.

The through hole 21 is not limited to having the above configuration, but may open into, for example, the third surface 7. In this case, the through hole 21 may penetrates from one surface region on the third surface 7 to another surface region located on a side opposite to the one surface.

The insert 1A of the first embodiment has a flow path 22 extending from the first surface 3 toward the second surface 5. The flow path 22 is a passage disposed in an interior of the insert 1 in order to supply a coolant to the cutting edge 13 during machining. A method for forming the flow path 22 is not particularly limited. The flow path 22 may be formed in the insert 1 by, for example, drilling, laser machining, and manufacturing by a 3D printer.

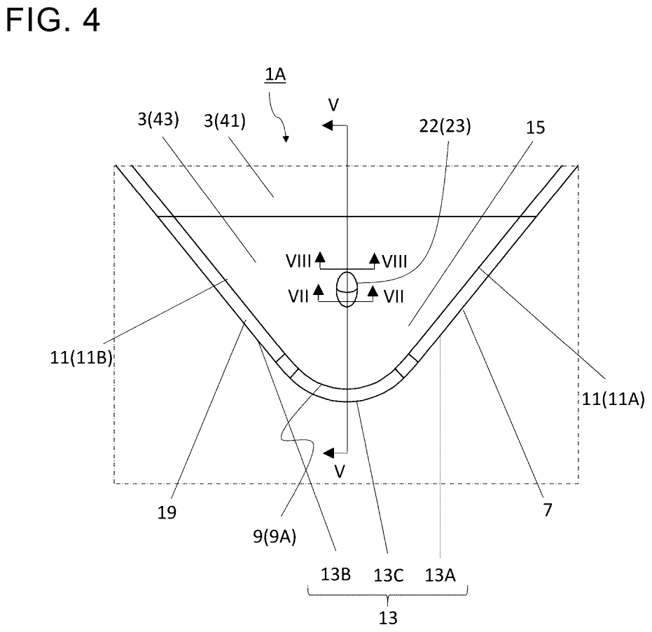

In a non-limiting embodiment illustrated in FIG. 4, the flow path 22 has an outflow port 23 that opens into the first surface 3. The outflow port 23 is a configuration for discharging the coolant that has flowed through the flow path 22. In the non-limiting embodiment illustrated in FIG. 4, the outflow port 23 has an oval shape as viewed from above. More specifically, the oval shape has a large length in an extending direction of the first flow path 25 as seen through from above, that is, a vertically elongated oval shape. The shape of the outflow port 23 is not limited to the above, but may be, for example, a circular shape, a laterally elongated oval shape, or an approximately triangular shape.

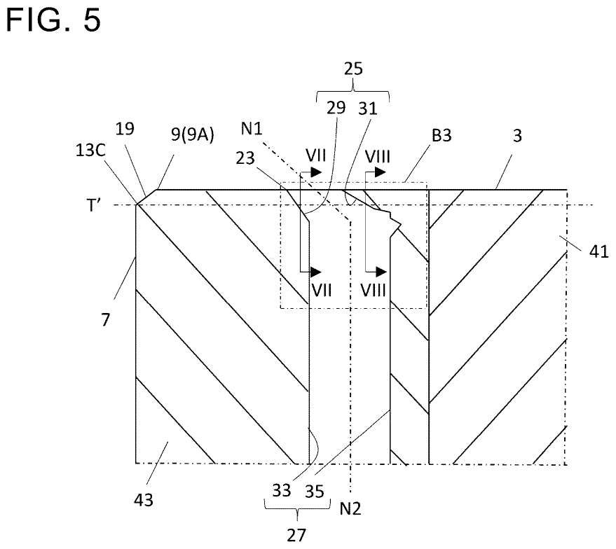

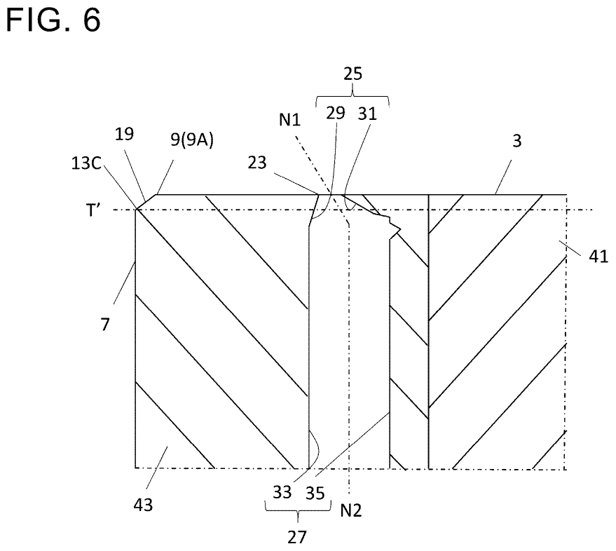

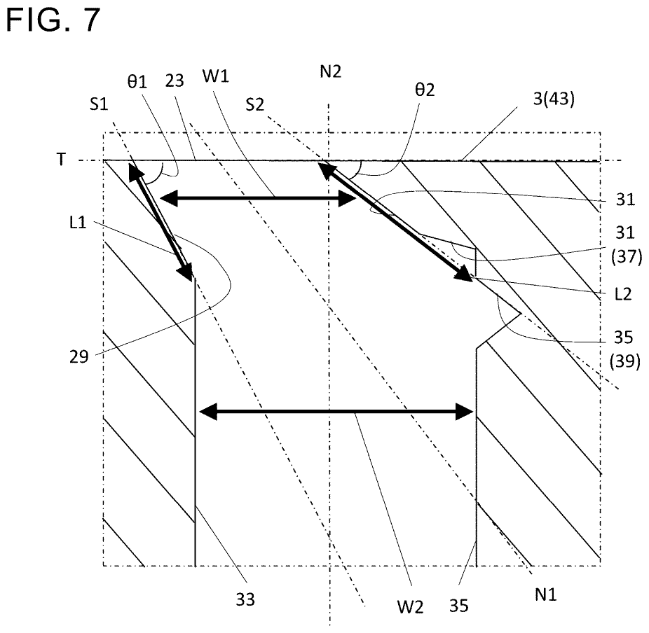

In the insert 1A of the first embodiment, the flow path 22 has a first flow path 25 extending from the outflow port 23 toward the second surface 5 as in a non-limiting embodiment illustrated in FIG. 5. As in a non-limiting embodiment illustrated in FIG. 7, a width of the first flow path 25 in a direction parallel to the first surface 3 increases as going away from the first surface 3 in a cross section (hereinafter referred to as a first cross section) that passes through a central axis of the first flow path 25 (hereinafter referred to as a first central axis N1) and is orthogonal to the first surface 3. Specifically, a width W1 of the first flow path 25 in the direction parallel to the first surface 3 increases as going away from the first surface 3 in the non-limiting embodiment illustrated in FIG. 7. This is also true for the configuration illustrated in FIG. 6.

FIG. 5 is a V-V cross section obtained by cutting the insert 1 along line V-V illustrated in FIG. 4. The V-V cross section is a cross section that has the first central axis N1 and is orthogonal to the first surface 3. A first cross section (V-V cross section) may have a central axis O of the insert 1. The line V-V coincides with a bisector of the first corner 9A in the non-limiting embodiment illustrated in FIG. 4. Therefore, the first cross section (V-V cross section) may be a cross section along the bisector of the first corner 9A. FIG. 6 is a diagram illustrating a modification of the first flow path 25 in the insert 1A of the first embodiment, and FIG. 6 corresponds to FIG. 5.

If a large part of the first surface 3 does not have the straight line shape and it is difficult to uniquely determine the direction parallel to the first surface 3 in the first cross section, the direction parallel to the first surface 3 may be a direction orthogonal to the central axis O of the insert 1 passing through a center of the first surface 3 and a center of the second surface 5. The first flow path 25 is formed by laser machining in the insert 1A of the first embodiment.

Ingenuity, such as reducing a distance between a cutting edge and an outflow port by disposing a flow path in an interior of an insert, has been applied to efficiently supply a coolant to the cutting edge in conventional technique. However, even with the above ingenuity, there is a limit to enhancement in flow velocity (injection pressure) of the coolant, and there is a possibility that the coolant could not be sufficiently supplied to the cutting edge.

In the insert 1A of the first embodiment, the width of the first flow path 25 in the direction parallel to the first surface 3 increases as going away from the first surface 3 in the first cross section. That is, because the first flow path 25 has a reverse-tapered shape, the flow velocity (injection pressure) of the coolant can be enhanced without restriction in a shape of the insert, and it becomes possible to efficiently supply the coolant to the cutting edge. Thus, with the insert 1A of the first embodiment, the coolant can be efficiently supplied to the cutting edge 13.

In the insert 1A of the first embodiment, the first flow path 25 in the cross section parallel to the first surface 3 has the oval shape, but without being limited to this, the shape thereof may be, for example, a circular shape and an approximately triangular shape. Also, the first flow path 25 in the cross section orthogonal to the first central axis N1 has the circular shape in the insert 1A of the first embodiment, but without being limited to this, the shape thereof may be, for example, an oval shape and an approximately triangular shape.

The first central axis N1 approaches the third surface 7 as approaching the outflow port 23 in the insert 1A of the first embodiment. With this configuration, the coolant that has flowed through the flow path 22 can be more efficiently discharged in a direction toward the cutting edge 13. Specifically, as in the non-limiting embodiment illustrated in FIG. 5, the first central axis N1 approaches the third surface 7 as approaching the outflow port 23 in the first cross section. In the non-limiting embodiment illustrated in FIG. 5, the first central axis N1 extends toward a top left so as to approach the third surface 7 illustrated on a left side in the drawing as approaching the outflow port 23 from an interior of the flow path 22.

In the non-limiting embodiment illustrated in FIG. 5, the first central axis N1 has a straight line shape and approaches the third surface 7 as the first central axis N1 approaches the outflow port 23. This may be rephrased as follows. The central axis N1 approaches the third surface 7 as approaching the first surface 3. More specifically, the first central axis N1 approaches the cutting edge 13 as approaching the outflow port 23 as in the non-limiting embodiment illustrated in FIG. 5. The first central axis N1 also approaches the first corner 9A as approaching the outflow port 23.

In the non-limiting embodiment illustrated in FIG. 5, the first flow path 25 has a first flow path wall 29 located near the third surface 7, and a second flow path wall 31 opposed to the first flow path wall 29. The first flow path 25 may be configured only with the first flow path wall 29 and the second flow path wall 31. The first flow path wall 29 and the second flow path wall 31 have a straight line shape in the first cross section as in the non-limiting embodiment illustrated in FIG. 5, but without being limited to this, both may have, for example, a curvilinear shape.

An angle formed by the first flow path wall 29 and the first surface 3 is larger than an angle formed by the second flow path wall 31 and the first surface 3 in a non-limiting embodiment illustrated in FIG. 7.

Specifically, as in the non-limiting embodiment illustrated in FIG. 7, if a straight line parallel to the first flow path wall 29 is a first imaginary straight line S1, a straight line parallel to the second flow path wall 31 is a second imaginary straight line S2, a straight line parallel to the first surface 3 is an imaginary extended line T, an angle formed by the first imaginary straight line S1 and the imaginary extended line T is a first angle θ1, and an angle formed by the second imaginary straight line S2 and the imaginary extended line T is a second angle θ2 in the first cross section, θ1>θ2.

If the first flow path wall 29 has the curvilinear shape, a straight line passing through a terminal point located on a side of the first surface 3 in the first flow path wall 29 and a terminal point located on a side of the second surface 5 in the first flow path wall 29 may be the first imaginary straight line S1. Also, if the second flow path wall 31 has the curvilinear shape, the second imaginary straight line S2 may be defined similarly. If the whole of the first surface 3 does not have the straight line shape in the first cross section, a straight line orthogonal to the central axis O of the insert 1 which passes through the center of the first surface 3 and the center of the second surface 5 may be the imaginary extended line T. The first angle θ1 is an angle that is relatively remote from the third surface 7 among angles formed by the first imaginary straight line S1 and the imaginary extended line T. The second angle θ2 is an angle that is relatively remote from the third surface 7 among angles formed by the second imaginary straight line S2 and the imaginary extended line T. The first angle θ1 and the second angle θ2 may be individually an acute angle.

With the above configuration, the coolant that has flowed through the flow path 22 can be more efficiently discharged in the direction toward the cutting edge 13.

As in the non-limiting embodiment illustrated in FIGS. 5 and 7, the second flow path wall 31 is longer than the first flow path wall 29 in the first cross section.

Specifically, if a length of the first flow path wall 29 is L1, and a length of the second flow path wall 31 is L2, L2>L1. Also, with this configuration, the coolant that has flowed through the flow path 22 can be more efficiently discharged in the direction toward the cutting edge 13.

In the insert 1A of the first embodiment, the first flow path wall 29 and the second flow path wall 31 individually approach the third surface 7 as approaching the outflow port 23 in the first cross section. With this configuration, the coolant that has flowed through the flow path 22 can be more efficiently discharged in the direction toward the cutting edge 13. In the non-limiting embodiment illustrated in FIG. 5, the whole of the first flow path wall 29 and the whole of the second flow path wall 31 individually approach the third surface 7 as approaching the outflow port 23.

In the non-limiting embodiment illustrated in FIG. 5, at least a part of the first flow path 25 is located closer to the second surface 5 than the land surface 19. Specifically, as in the non-limiting embodiment illustrated in FIG. 5, a part of the first flow path 25 is located closer to the second surface 5 than an imaginary extended line T′ that is a straight line which passes through a terminal point located on a side of the second surface 5 in the land surface 19, and is parallel to the first surface 3. This contributes to maintaining a length of the first flow path 25, and therefore, the coolant that has flowed through the flow path 22 can be more efficiently discharged in the direction toward the cutting edge 13.

In the insert 1A of the first embodiment, the flow path 22 further has a second flow path 27 extending from the first flow path 25 toward the second surface 5. In the insert 1A of the first embodiment, in a cross section (hereinafter referred to as a second cross section) that passes through a central axis of the second flow path 27 (hereinafter referred to as a second central axis N2) and is orthogonal to the first surface 3, a width of the second flow path 27 in a direction orthogonal to the second central axis N2 is constant.

Specifically, in the non-limiting embodiment illustrated in FIGS. 5 and 7, a width W2 of the second flow path 27 in the direction orthogonal to the second central axis N2 is constant from a side of the first surface 3 toward a side of the second surface 5. The term “constant” as used herein need not be strictly identical, but the width W2 of the second flow path 27 may be recognized as constant if, for example, a maximum value and a minimum value of the width W2 of the second flow path 27 are within ±5% with respect to an average value of the width W2 of the second flow path 27.

FIG. 5 is a V-V cross section obtained by cutting the insert 1 along line V-V illustrated in FIG. 4. The V-V cross section is a cross section that has the second central axis N2 and is orthogonal to the first surface 3. The second cross section (V-V cross section) may have the central axis O of the insert 1.

In the insert 1A of the first embodiment, the first central axis N1 and the second central axis N2 are located on the same cross section, and therefore, the cross section in FIG. 5 is the first cross section and also the second cross section. However, without being limited to the above case, the first cross section and the second cross section may be located on different flat surfaces. The second flow path 27 is formed by drilling in the insert 1A of the first embodiment.

Although a shape of the second flow path 27 in a cross section orthogonal to the second central axis N2 is not particularly limited, the shape is a circular shape in the insert 1A of the first embodiment. The second flow path 27 connects to the first flow path 25 in the insert 1A of the first embodiment. Specifically, an end part on a side of the first surface 3 in the second flow path 27 connects to an end part on a side of the second surface 5 in the first flow path 25 in the non-limiting embodiment illustrated in FIG. 5.

An inner diameter of the first flow path 25 is identical with an inner diameter of the second flow path 27 at the above end part, or the inner diameter of the first flow path 25 is smaller than the inner diameter of the second flow path 27. With this configuration, it is easy to reduce risk of fluid pressure loss and improve supply efficiency of the coolant.

In the non-limiting embodiment illustrated in FIG. 5, the second flow path 27 has a third flow path wall 33 located near the third surface 7, and a fourth flow path wall 35 opposed to the third flow path wall 33. The second flow path 27 may be configured with the third flow path wall 33 and the fourth flow path wall 35. The third flow path wall 33 and the fourth flow path wall 35 have a straight line shape in the second cross section as in the non-limiting embodiment illustrated in FIG. 5, but without being limited to this, both may have, for example, a curvilinear shape. The third flow path wall 33 connects to the first flow path wall 29, and the fourth flow path wall 35 connects to the second flow path wall 31 in the non-limiting embodiment illustrated in FIG. 5.

The second flow path wall 31 has a first recess 37 on a part thereof connecting to the second flow path 27 in the second cross section as in the non-limiting embodiment illustrated in FIG. 7. In other words, the first recess 37 is located at an end part on a side of the second surface 5 in the second flow path wall 31, and connects to the fourth flow path wall 35. The end part on the side of the second surface 5 in the second flow path wall 31 is susceptible to impact of the coolant that has flowed through the second flow path 27. Therefore, by disposing the first recess 37 on the second flow path wall 31, the impact can be mitigated to enhance durability of the first flow path 25.

The fourth flow path wall 35 has a second recess 39 on a part thereof connecting to the first flow path 25 in the first cross section as in the non-limiting embodiment illustrated in FIG. 7. In other words, the second recess 39 is located at an end part on a side of the first surface 3 in the fourth flow path wall 35, and connects to the second flow path wall 31. The coolant that has flowed through the second flow path 27 tends to collide with an end part on a side of the second surface 5 in the second flow path wall 31, and tends to flow backward in a flow direction of the coolant. Therefore, by disposing the second recess 39 on the fourth flow path wall 35, the coolant flowed backward can be received by the second recess 39, thereby avoiding excessive backflow of the coolant.

The first recess 37 and the second recess 39 have a V-shape in the non-limiting embodiment illustrated in FIG. 7, but without being limited to this, both may have, for example, a U-shape having a concave curvilinear part on a bottom part.

If the second flow path wall 31 and the fourth flow path wall 35 have respectively the first recess 37 and the second recess 39, the second flow path wall 31 and the fourth flow path wall 35 do not strictly have the straight line shape in the first cross section and the second cross section. However, because the first recess 37 and the second recess 39 are small relative to the whole of the flow path 22, the second flow path wall 31 and the fourth flow path wall 35 are also recognized as the straight line shape in the above case. Specifically, the shape of the second flow path wall 31 and the shape of the fourth flow path wall 35 in the absence of the first recess 37 and the second recess 39 are respectively the shape of the second flow path wall 31 and the shape of the fourth flow path wall 35.

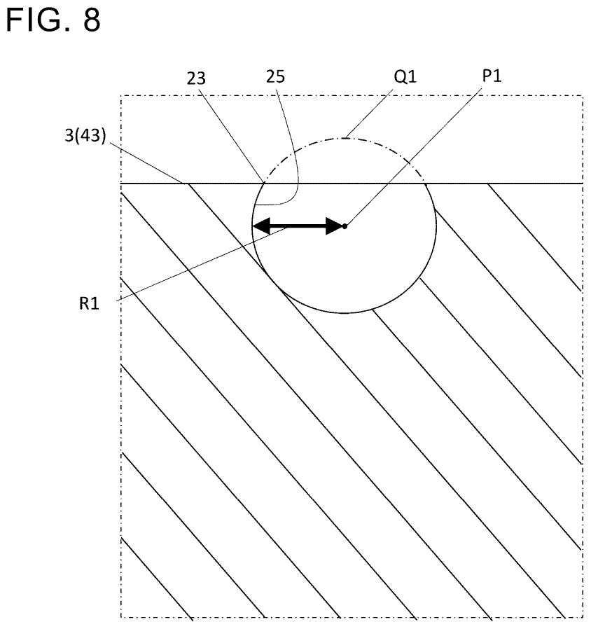

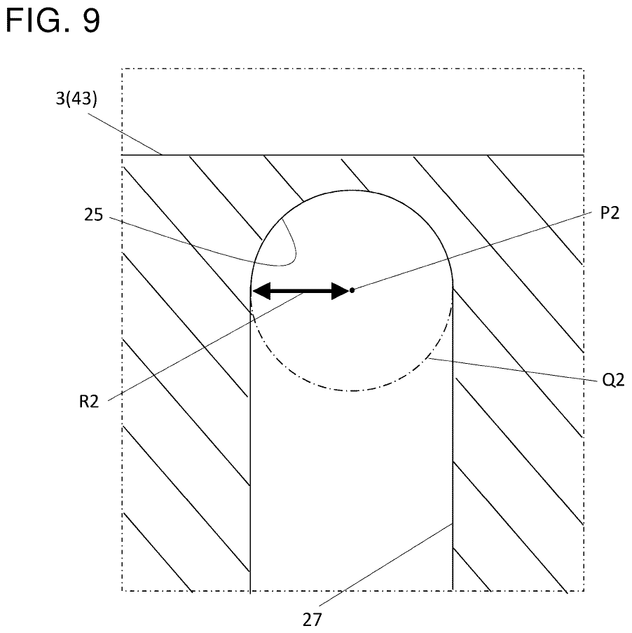

In the insert 1A of the first embodiment, a shape of the first flow path 25 in a cross section orthogonal to the first surface 3 and the first cross section (hereinafter referred to as a third cross section) is a circular shape. Specifically, as in a non-limiting embodiment illustrated in FIGS. 8 and 9, of arbitrary two third cross sections, the cross section in which the first flow path 25 is located on a side of the first surface 3 is a VII-VII cross section, and the cross section in which the first flow path 25 is located on a side of the second surface 5 is a VIII-VIII cross section. The shape of the first flow path 25 is also the circular shape in both cross sections.

In the insert 1A of the first embodiment, the VII-VII cross section and the VIII-VIII cross section indicate respectively the cross sections cut along line VII-VII and line VIII-VIII illustrated in FIGS. 4 and 5.

Because the first flow path 25 connects to the first surface 3 in the VII-VII cross section, a shape of a first imaginary circle Q1 centered at a first point Pl illustrated in FIG. 8 is the shape of the first flow path 25. Because the first flow path 25 connects to the second flow path 27 in the VIII-VIII cross section, a shape of a second imaginary circle Q2 centered at a second point P2 illustrated in FIG. 9 is the shape of the first flow path 25. Because the first central axis N1 passes through the first point P1 and the second point P2, the first point P1 and the second point P2 may be a part of the first central axis N1.

In the insert 1A of the first embodiment, an inner diameter of the first flow path 25 in the third cross section gradually increases as the first flow path 25 becomes farther away from the first surface 3. Specifically, as in the non-limiting embodiment illustrated in FIGS. 8 and 9, if an inner diameter of the first imaginary circle Q1 is R1, and an inner diameter of the second imaginary circle Q2 is R2, R2>R1. With this configuration, it is easy to improve the supply efficiency of the coolant.

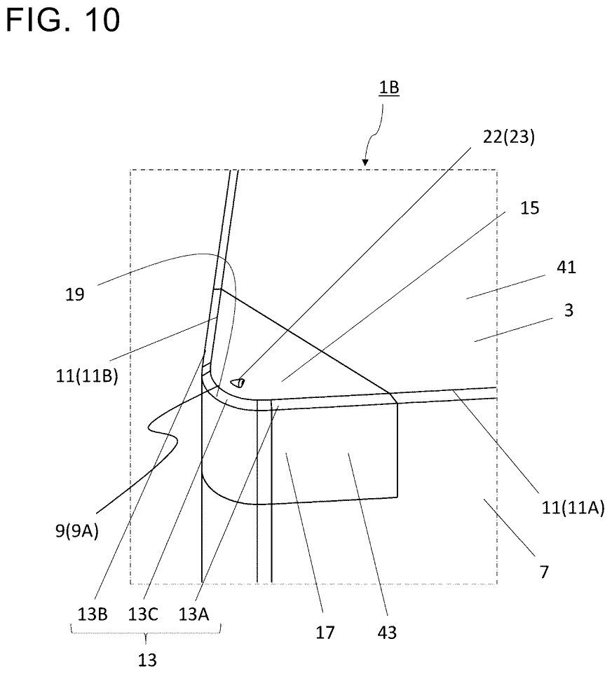

In the insert 1B of the second embodiment, the following description except for a content described later (the content regarding a flow path 22) is the same as in the insert 1A of the first embodiment. Therefore, as to the description except for the content described later, the description of the first embodiment is referred to and a detailed description is omitted here. FIGS. 10 to 14 referred to in the insert 1B of the second embodiment correspond respectively FIGS. 3 to 5, 8, and 9 referred to in the insert 1A of the first embodiment.

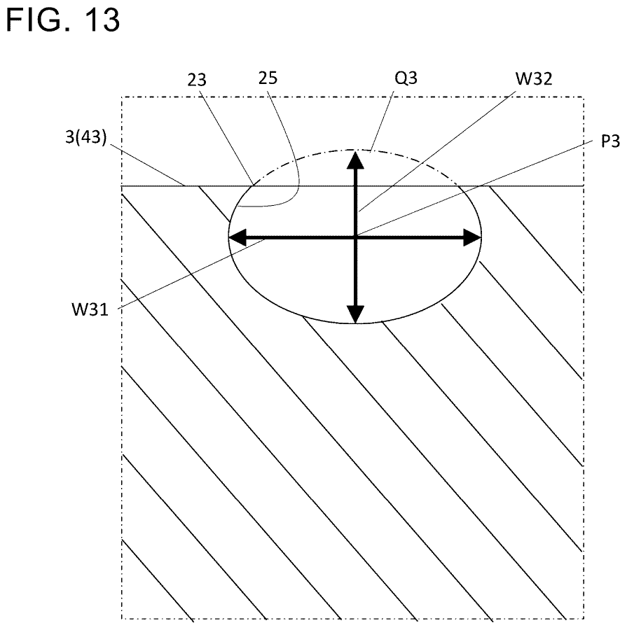

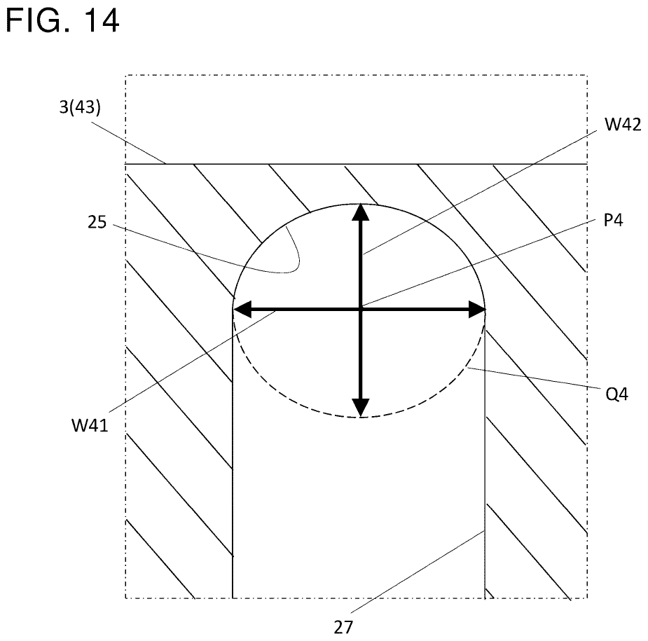

In the insert 1B of the second embodiment, a shape of the first flow path 25 in the third cross section is an oval shape. Specifically, as in a non-limiting embodiment illustrated in FIGS. 13 and 14, of arbitrary two third cross sections, the cross section in which the first flow path 25 is located on a side of the first surface 3 is a XII-XII cross section, and the cross section in which the first flow path 25 is located on a side of the second surface 5 is a XIII-XIII cross section. The shape of the first flow path 25 is also the oval shape in both cross sections.

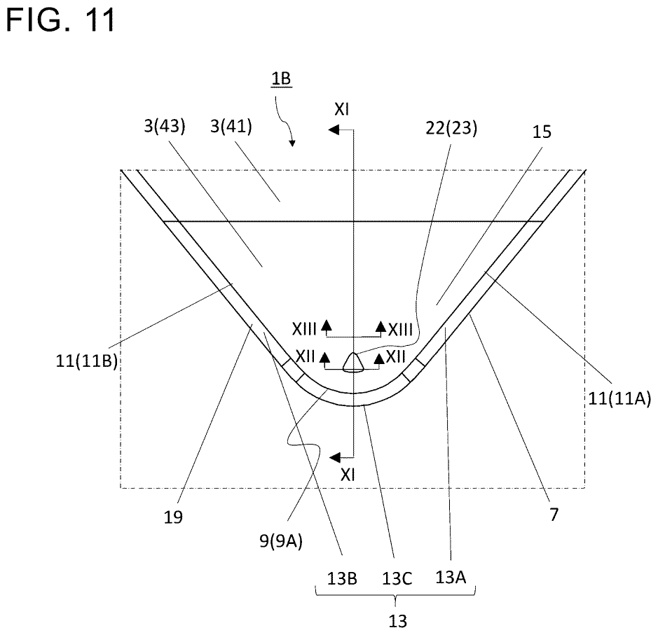

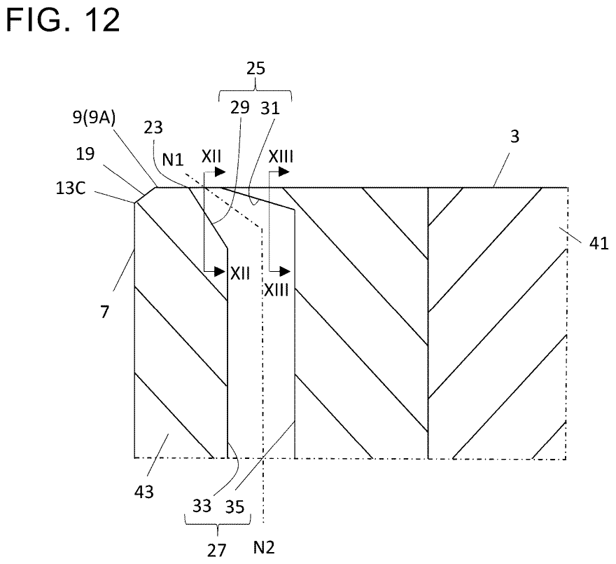

In the insert 1B of the second embodiment, the XII-XII cross section and the XIII-XIII cross section indicate respectively the cross sections cut along line XII-XII and line XIII-XIII illustrated in FIG. 11 and 12.

Because the first flow path 25 connects to the first surface 3 in the XII-XII cross section, a shape of a third imaginary oval Q3 centered at a third point P3 illustrated in FIG. 13 is the shape of the first flow path 25. Because the first flow path 25 connects to the second flow path 27 in the XIII-XIII cross section, a shape of a fourth imaginary oval Q4 centered at a fourth point P4 illustrated in FIG. 14 is the shape of the first flow path 25. Because the first central axis N1 passes through the third point P3 and the fourth point P4, the third point P3 and the fourth point P4 may be a part of the first central axis N1.

A lateral width of the first flow path 25 in the third cross section is larger than a longitudinal width of the first flow path 25 in the insert 1B of the second embodiment. Here, the lateral width is a width in a direction parallel to the first surface 3, and the longitudinal width is a width in a direction orthogonal to the first surface 3. Hereinafter, unless otherwise noted, the lateral width is the lateral width of the first flow path 25 in the third cross section, and the longitudinal width is the longitudinal width of the first flow path 25 in the third cross section.

As in the non-limiting embodiment illustrated in FIGS. 13 and 14, a lateral width W31 of the third imaginary oval Q3 is larger than a longitudinal width W32 of the third imaginary oval Q3, and a lateral width W41 of the fourth imaginary oval Q4 is larger than a longitudinal width W42 of the fourth imaginary oval Q4. With this configuration, it is possible to discharge the coolant in a wide range, thereby facilitating improvement in supply efficiency of the coolant.

If a large part of the first surface 3 does not have the straight line shape and it is difficult to uniquely determine the direction parallel to the first surface 3 and the direction orthogonal to the first surface 3 in the third cross section, the direction parallel to the first surface 3 may be a direction orthogonal to the central axis O of the insert 1, and the direction orthogonal to the first surface 3 may be a direction parallel to the central axis O of the insert 1.

In the insert 1B of the second embodiment, the longitudinal width gradually increases as the first flow path 25 becomes farther away from the first surface 3. Specifically, as in the non-limiting embodiment illustrated in FIGS. 13 and 14, the longitudinal width W42 of the fourth imaginary oval Q4 is larger than the longitudinal width W32 of the third imaginary oval Q3. With this configuration, the second angle θ2 tends to become small, thereby facilitating improvement in supply efficiency of the coolant.

In the insert 1B of the second embodiment, a ratio of the longitudinal width to the lateral width gradually increases as the first flow path 25 becomes farther away from the first surface 3. Specifically, W42/W41>W32/W31 in the non-limiting embodiment illustrated in FIGS. 13 and 14. With this configuration, it is easy to improve the supply efficiency of the coolant.

The lateral width is constant in the insert 1B of the second embodiment. Specifically, W31=W41 in the non-limiting embodiment illustrated in FIGS. 13 and 14. The term “constant” as used herein need not be strictly the same, but the lateral width may be recognized as constant, for example, if a maximum value and a minimum value of the lateral width are within 15% with respect to an average value of the lateral width.

In the insert 1B of the second embodiment, the outflow port 23 has an approximately triangular shape as viewed from above. Specifically, the width of the outflow port 23 in the direction orthogonal to the first central axis N1 increases as approaching a side of the third surface 7 in the non-limiting embodiment illustrated in FIGS. 11 and 12. In the insert 1B of the second embodiment, because the lateral width of the first flow path 25 in the third cross section is larger than the longitudinal width thereof, a vertex angle located near the central axis of the insert 1 is larger than 60° in the non-limiting embodiment illustrated in FIG. 11.

Examples of material of the insert 1 may include cemented carbide, cermet, ceramics, cBN (cubic boron nitride), and PCD (polycrystalline diamond).

Examples of composition of the cemented carbide may include WC (tungsten carbide)—Co, WC—TiC (titanium carbide)—Co, and WC—TiC—TaC (tantalum carbide)—Co, in which WC, TiC, and TaC are hard particles and Co is a binding phase. The cermet is a sintered composite material obtained by compositing metal into a ceramic component. Examples of the cermet may include compounds composed mainly of TiC or TiN (titanium nitride). It should be clear that the material of the insert 1 is not limited to these.

The insert 1 may be configured with a single member composed of the material exemplified above, or may be configured with a plurality of members composed of the material exemplified above.

The insert 1 of the present embodiment is configured with a base part 41 and a cutting part 43, and has a polygonal plate shape as a whole as in the non-limiting embodiment illustrated in FIG. 1. The base part 41 has an approximately polygonal plate shape, and a part of a corner has a notched portion. The cutting part 43 is designed to be joined to the notched portion by using a brazing material, etc. The phrase that the cutting part 43 is joined to the base part 41 may be rephrased as follows. The cutting part 43 is attached to the base part 41. If the insert 1 is configured with the single member as described above, the whole of the insert 1 may be the cutting part 43.

In the non-limiting embodiment illustrated in FIGS. 3 and 5, the cutting part 43 has a part of the first surface 3, a part of the third surface 7, the first corner 9A, a part of the first side 11A, a part of the second side 11B, the cutting edge 13, the land surface 19, and the flow path 22. As to the flow path 22, the outflow port 23 and the first flow path 25 may be located on the cutting part 43, and the second flow path 27 may be located on the base part 41. The cutting part 43 has, as a second surface, a surface located on a side opposite to the first surface 3. If the whole of the insert 1 is the cutting part 43, the cutting part 43 has the second surface 5.

In cases where a material including relatively high hardness, such as cBN and PCD, is used as a material of the cutting part 43, and, for example, cemented carbide, cermet, or ceramics is used as a material of the base part 41, it is possible to inexpensively manufacture the insert 1 that has high durability with respect to cutting load. For example, this may correspond to the case where the base part 41 is composed of cemented carbide and the cutting part 43 is composed of cBN or PCD. Hardness of the base part 41 and the cutting part 43 can be evaluated by measuring Vickers hardness of their respective parts.

If the cutting part 43 is composed of the material including relative high hardness, such as cBN and PCD, as in the insert 1 of the present embodiment, it is difficult to apply micro-machining to the shape of the cutting part 43, and it is difficult to maintain the supply efficiency of the coolant. However, with the insert 1 of the present embodiment, the coolant can be more efficiently supplied to the cutting edge 13 by forming the first flow path 25 in the reverse-tapered shape, without restriction in the shape of the insert 1. Consequently, if the cutting part 43 is composed of the above material, it is possible to further take the advantage that the first flow path 25 disposed in the cutting part 43 is formed in the reverse-tapered shape.

Although the insert 1 may be configured with the base part 41 and the cutting part 43 as described above, the insert 1 may have a coating layer (not illustrated) that covers the surface of the insert 1, as an example other than the above-mentioned configuration. The coating layer may cover the whole or a part of the surface of the insert 1.

Examples of material of the coating layer may include aluminum oxide (alumina), and carbide, nitride, oxide, carbon oxide, nitrogen oxide, carbonitride, and carbonitride oxide of titanium. The coating layer may include one or a plurality of the above-mentioned materials.

The coating layer may be configured with one layer, or may have a laminated configuration of a plurality of layers. Materials of the coating layer are not limited to these. The coating layer can be located on the surface of the insert 1 by using, for example, Chemical Vapor Deposition (CVD) method or Physical Vapor Deposition (PVD) method.

Examples of the coolant may have water-insoluble oils and water-soluble oils. Examples of water-insoluble oils may have oil-based, inert extreme-pressure type, and active extreme-pressure type cutting fluids. Examples of water-soluble oils may have emulsion, soluble, and solution type cutting fluids. The coolant is not limited to liquid, but may be gas, such as inert gas. The coolant may be appropriately selected and used according to the material of a workpiece.

### Cutting Tools

A cutting tool 101 in a non-limiting embodiment of the present disclosure is described below with reference to the drawings.

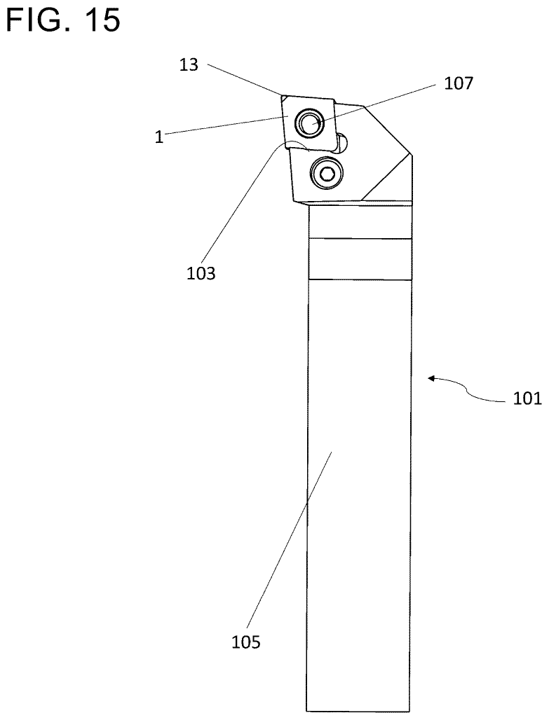

The cutting tool 101 of the present embodiment has a holder 105 having a pocket 103 located on a side of a front end, and the insert 1 of the present embodiment located in the pocket 103 as in a non-limiting embodiment illustrated in FIG. 15. The insert 1 is attached so that at least a part of the cutting edge 13 is protruded from the front end of the holder 105 in the cutting tool 101 of the present embodiment.

The holder 105 has a long and narrow bar shape. The pocket 103 is disposed on the side of the front end of the holder 105. The pocket 103 is a part that permits attachment of the insert 1 and opens into a front end surface of the holder 105. Because the pocket 103 also opens into a lateral surface of the holder 105, it is easy to attach the insert 1. Specifically, the pocket 103 has a seating surface parallel to a lower surface of the holder 105, and a constraining lateral surface inclined with respect to the seating surface.

The insert 1 is located in the pocket 103. The lower surface of the insert 1 may be in direct contact with the pocket 103. Alternatively, a sheet may be held between the insert 1 and the pocket 103.

The insert 1 is attached so that the cutting edge 13 is protruded outward from the holder 105. In the present embodiment, the insert 1 is attached to the holder 105 by a clamping member 107. That is, a head part of the clamping member 107 is pressed against an inner wall of a through hole 21 of the insert 1 so as to constrain the insert 1 in the pocket 103.

For example, steel and cast iron may be used as a material of the holder 105. If the material of the holder 105 is steel, the holder 105 has high toughness.

The present embodiment exemplifies a cutting tool used in a so-called turning process. Examples of the turning process may have internal diameter machining, external diameter machining, and grooving process. The cutting tool is not limited to ones which are used for the turning process. For example, the insert 1 of the above embodiment may be used for a cutting tool used in a milling process.

### Methods for Manufacturing Machined Product

A method for manufacturing a machined product in a non-limiting embodiment of the present disclosure is described below with reference to the drawings.

The machined product is manufactured by machining a workpiece 201. The method for manufacturing the machined product in the embodiment has the following steps:
(1) rotating the workpiece 201;
(2) bringing the cutting tool 101 represented by the above embodiment into contact with the workpiece 201 being rotated; and
(3) moving the cutting tool 101 away from the workpiece 201.

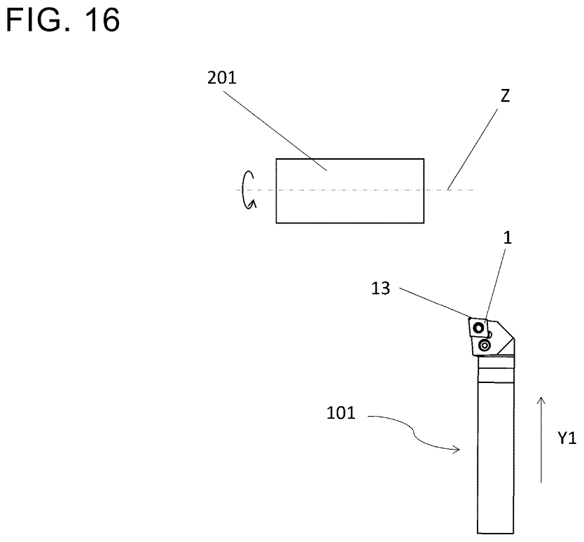

More specifically, firstly, the workpiece 201 is rotated around an axis Z, and the cutting tool 101 is relatively brought near the workpiece 201 as in a non-limiting embodiment illustrated in FIG. 16.

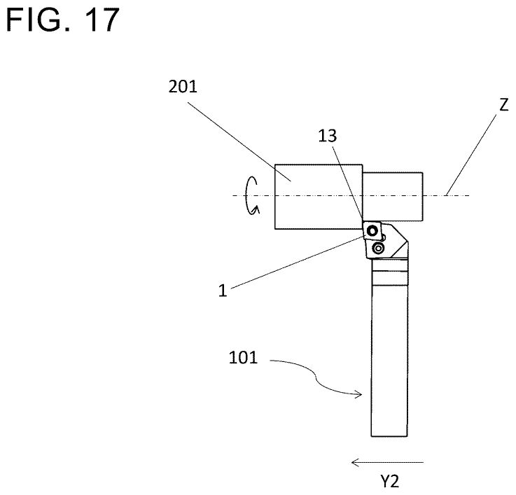

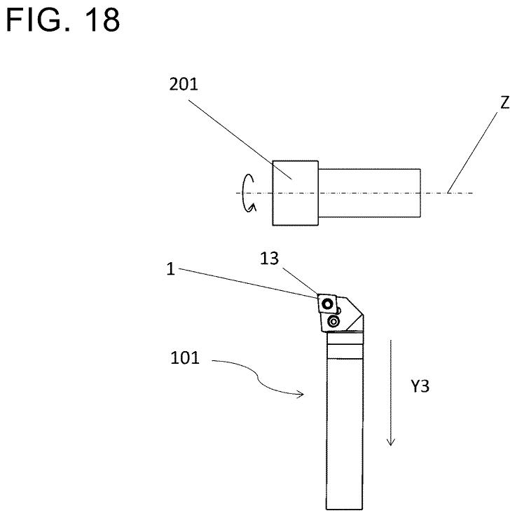

Subsequently, the workpiece 201 is cut out by bringing the cutting edge 13 of the cutting tool 101 into contact with the workpiece 201 as in a non-limiting embodiment illustrated in FIG. 17. Thereafter, the cutting tool 101 is relatively moved away from the workpiece 201 as in a non-limiting embodiment illustrated in FIG. 18.

In the present embodiment, the cutting tool 101 is brought near the workpiece 201 by moving the cutting tool 101 in a Y1 direction in a state where the axis Z is fixed and the workpiece 201 is rotated. In FIG. 17, the workpiece 201 is cut out by bringing the cutting edge 13 into contact with the workpiece 201 being rotated, and then by moving the cutting tool 101 in a Y2 direction. In FIG. 18, the cutting tool 101 is moved away by moving the cutting tool 101 in a Y3 direction in a state where the workpiece 201 is rotated.

In the machining with the manufacturing method of the present embodiment, the cutting tool 101 is brought into contact with the workpiece 201, or the cutting tool 101 is moved away from the workpiece 201 by moving the cutting tool 101 in the individual steps. Naturally, there is no intention to limit to this embodiment.

For example, the workpiece 201 may be brought near the cutting tool 101 in the step (1). Similarly, the workpiece 201 may be moved away from the cutting tool 101 in the step (3). If it is desired to continue the machining, the step of bringing the cutting edge 13 of the insert 1 into contact with different portions of the workpiece 201 may be repeated while keeping the workpiece 201 rotated.

Examples of material of the workpiece 201 may include carbon steel, alloy steel, stainless steel, cast iron, and nonferrous metals.
In an embodiment, [1] a cutting insert has a cutting part. The cutting part has a first surface having a rake surface region, a second surface located on a side opposite to the first surface, a third surface that is located between the first surface and the second surface and has a flank surface region, and a flow path extending from the first surface toward the second surface. The flow path has an outflow port opening into the first surface, and a first flow path extending from the outflow port toward the second surface. In a first cross section passing through a central axis of the first flow path and being orthogonal to the first surface, a width of the first flow path in a direction parallel to the first surface increases as going away from the first surface.

[2] In the cutting insert of the above [1], the central axis may approach the third surface as approaching the outflow port.

[3] In the cutting insert of the above [1] or [2], the first flow path has a first flow path wall located near the third surface, and a second flow path wall opposed to the first flow path wall. An angle formed by the first flow path wall and the first surface may be larger than an angle formed by the second flow path wall and the first surface in the first cross section.

[4] In the cutting insert of the above [3], the first flow path wall and the second flow path wall may individually approach the third surface as approaching the outflow port in the first cross section.

[5] In the cutting insert of any one of the above [1] to [4], the cutting part may further have a land surface located between the first surface and the third surface. At least a part of the first flow path may be located closer to the second surface than the land surface.

[6] In the cutting insert of any one of the above [1] to [5], the flow path may further have a second flow path extending from the first flow path toward the second surface. A width of the second flow path in a direction parallel to the first surface may be constant from a side of the first surface toward a side of the second surface in a second cross section that passes through a central axis of the second flow path and is orthogonal to the first surface.

[7] In the cutting insert of the above [6], the first flow path may have a first flow path wall located near the third surface, and a second flow path wall opposed to the first flow path wall. The second flow path wall may have a first recess on a part connecting to the second flow path in the second cross section.

[8] In the cutting insert of the above [6] or [7], the first flow path may have a first flow path wall located near the third surface, and a second flow path wall opposed to the first flow path wall. The second flow path may have a third flow path wall located near the third surface, and a fourth flow path wall opposed to the third flow path wall. The fourth flow path wall may have a second recess on a part connecting to the second flow path wall in the first cross section.

[9] In the cutting insert of any one of the above [1] to [8], the first flow path may have an oval shape in a third cross section orthogonal to the first surface and the first cross section.

[10] In the cutting insert of the above [9], a lateral width of the first flow path may be larger than a longitudinal width of the first flow path in the third cross section.

[11] In the cutting insert of the above [10], as the first flow path becomes farther away from the first surface, the longitudinal width may gradually increase, and a ratio of the longitudinal width to the lateral width may gradually increase.

[12] In the cutting insert of any one of the above [1] to [11], the cutting insert may further have a base part with the cutting part joined thereto. The base part may be composed of cemented carbide, and the cutting part may be composed of cubic boron nitride or polycrystalline diamond.

[13] A cutting tool may have a holder having a pocket located on a side of a front end, and the cutting insert of any one of the above [1] to [12], the cutting insert being located in the pocket.

[14] A method for manufacturing a machined product may have rotating a workpiece, bringing the cutting tool of the above [13] into contact with the workpiece being rotated, and moving the cutting tool away from the workpiece.

Although the invention in the present disclosure has been described with reference to the drawings and the embodiments, the invention in the present disclosure is not limited to the foregoing embodiments. In other words, various changes of the invention in the present disclosure may be made within the scope presented in the present disclosure, and embodiments obtainable by suitably combining technical means individually disclosed in different embodiments are also included in the technical scope of the invention in the present disclosure. That is, it should be noted that it is easy for those skilled in the art to make various modifications or fixes on the basis of the present disclosure. It should also be noted that these modifications or fixes are included in the scope of the present disclosure.

### Description of the Reference Numeral

1A, 1B cutting insert (insert)
3 first surface (upper surface)
5 second surface (lower surface)
7 third surface (lateral surface)
9 corner
9A first corner
9B second corner
9C third corner
11 side
11A first side
11B second side
13 cutting edge
13A first cutting edge
13B second cutting edge
13C first corner cutting edge
15 rake surface region
17 flank surface region
19 land surface
21 through hole
22 flow path
23 outflow port
25 first flow path
27 second flow path
29 first flow path wall
31 second flow path wall
33 third flow path wall
35 fourth flow path wall
37 first recess
39 second recess
41 base part
43 cutting part
101 cutting tool
103 pocket
105 holder
107 clamping member
201 workpiece
   N1, N2 central axis
   W1, W2, W31, W32, W41, W42 width
   O central axis of insert
   S1, S2 imaginary straight line
   T, T′ imaginary extended line
   θ1 first angle
   θ2 second angle
   L1, L2 length
   P1 to P4 center of imaginary circle (imaginary oval)
   Q1 to Q4 imaginary circle (imaginary oval)
   R1, R2 inner diameter
   Z axis
   Y1 to Y3 movement direction

1. A cutting insert, comprising:
a cutting part comprising
a first surface comprising a rake surface region,
a second surface located on a side opposite to the first surface,
a third surface being located between the first surface and the second surface and comprising a flank surface region, and
a flow path extending from the first surface toward the second surface,
the flow path comprising
an outflow port opening into the first surface, and
a first flow path extending from the outflow port toward the second surface,
wherein in a first cross section passing through a central axis of the first flow path and being orthogonal to the first surface,
a width of the first flow path in a direction parallel to the first surface increases as going away from the first surface.

2. The cutting insert according to claim 1, wherein the central axis approaches the third surface as approaching the outflow port.

3. The cutting insert according to claim 1, wherein
the first flow path comprises
a first flow path wall located near the third surface, and
a second flow path wall opposed to the first flow path wall, and
an angle formed by the first flow path wall and the first surface is larger than an angle formed by the second flow path wall and the first surface in the first cross section.

4. The cutting insert according to claim 3, wherein the first flow path wall and the second flow path wall individually approach the third surface as approaching the outflow port in the first cross section.

5. The cutting insert according to claim 1, wherein
the cutting part further comprises a land surface located between the first surface and the third surface, and
at least a part of the first flow path is located closer to the second surface than the land surface.

6. The cutting insert according to claim 1, wherein
the flow path further comprises a second flow path extending from the first flow path toward the second surface, and
a width of the second flow path in a direction parallel to the first surface is constant from a side of the first surface toward a side of the second surface in a second cross section passing through a central axis of the second flow path and being orthogonal to the first surface.

7. The cutting insert according to claim 6, wherein
the first flow path comprises
a first flow path wall located near the third surface, and
a second flow path wall opposed to the first flow path wall, and
the second flow path wall comprises a first recess on a part connecting to the second flow path in the second cross section.

8. The cutting insert according to claim 6, wherein,
the first flow path comprises
a first flow path wall located near the third surface, and
a second flow path wall opposed to the first flow path wall,
the second flow path comprises
a third flow path wall located near the third surface, and
a fourth flow path wall opposed to the third flow path wall, and
the fourth flow path wall comprises a second recess on a part connecting to the second flow path wall in the first cross section.

9. The cutting insert according to claim 1, wherein the first flow path has an oval shape in a third cross section orthogonal to the first surface and the first cross section.

10. The cutting insert according to claim 9, wherein a lateral width of the first flow path is larger than a longitudinal width of the first flow path in the third cross section.

11. The cutting insert according to claim 10, wherein as the first flow path becomes farther away from the first surface,
the longitudinal width gradually increases, and
a ratio of the longitudinal width to the lateral width gradually increases.

12. The cutting insert according to claim 1, further comprising:
a base part with the cutting part joined thereto, wherein
the base part comprises cemented carbide, and the cutting part comprises cubic boron nitride or polycrystalline diamond.

13. A cutting tool, comprising:
a holder comprising a pocket located on a side of a front end; and
the cutting insert according to claim 1, the cutting insert being located in the pocket.

14. A method for manufacturing a machined product, comprising:
rotating a workpiece;
bringing the cutting tool according to claim 13 into contact with the workpiece being rotated; and
moving the cutting tool away from the workpiece.
